(19) United States
(12) Patent Application Publication
(10) Pub. No.: US 2003/0006317 A1
(43) Pub. Date: Jan. 9, 2003

(54) Spot sprinkler

(76) Inventor: Carl T. McLuen, Sequim, WA (US)

Correspondence Address: CARL T. MCLUEN, 455 WOODCOCK ROAD, SEQUIM, WA, 98382, US

(21) Appl. No.: 09/885,357

(22) Filed: Jun. 21, 2001

(51) Int. Cl. B05B 15/00

(52) U.S. Cl. 239/547; 239/214

(57) ABSTRACT

A spot sprinkler with means to clamp on and connect into the side of a soft hose, such as a “soaker” hose. Snap on diverter attachments are capable of generating and directing a spray pattern to plants in any direction from the sprayer connection. The sprayer has a small straight orifice directly accessible for any clean out that may be required. Installation or relocation of the sprinklers is accomplished without use of any tool. Flow ratings for each size of spot sprinkler enable calculation of water directed to individual plantings. By accurate measurable spraying, overall water use can be reduced. The few small, simple parts are inexpensive to produce. A prime objective of this uncomplicated invention is to foster use by the average homeowner.

### CROSS REFERENCE TO RELATED APPLICATIONS

(Not applicable)

### FEDERALLY SPONSORED R & D

(Not applicable)

### BACKGROUND

1. Field of Invention

This invention relates to spot sprinkler systems, specifically the means to water individual plants, shrubs, flowers, or small trees economically and effectively.

2. Prior Art

Most sprinkling equipment to date provides area water capability, or utilizes “soaker” hoses or drip systems which clog or silt up. Drip systems use very small orifices which are prone to clogging, and have no clean-out provisions. Water filters available to alleviate some of the problems also clog, are difficult to service, and have very limited capacity.

It has not been possible to provide water adequately where needed without wasting water. In addition, relocation of the individual sprinklers has been difficult, and the quantity of water delivered to a specific area is unknown. Above ground equipment is usually unsightly. Pop-up sprinklers require extensive trenching for conduit and sprinkler heads, and are also prone to entanglement with weeds and grass roots.

### SUMMARY

My spot watering invention provides an inexpensive and versatile means of watering small areas, or individual plants, in a landscaped area. The sprinkler devised is very adaptable to changes or relocations in the planted area. The sprinkler was specifically designed to be used by the average home owner, and does not involve the use of tools or measuring devices. The accurate placement and flow rate will reduce wastage of limited water supplies.

The objects and advantages of this invention are as follows:

1. To provide small, individual spot sprinklers which can be quickly and easily attached to a soft hose routed through landscaped areas, or farm plots.

2. To provide directional control of the spray head to specific plants or areas.

3. To enable access to the primary orifice for any rodding out or clearing which may be required.

4. To enable easy removal of the spot sprinkler from the hose, and relocation to another spot.

5. To provide a design with few and simple parts suitable for low cost production by plastic injection molding and automatic machine processes

6. To provide a weather resistant sprinkler using stainless metals and plastic such as poly-propylene or high density polyethylene

7. To provide uniform primary orifices of thin wall (hypodermic type) tubing to enable accurate flow ratings for each size.

8. To provide variations which use many common parts

9. Further objects and advantages will be apparent from the following drawings and descriptions.

There are no hidden parts, and no tools required to install or remove the sprinklers. Common round toothpicks and electrical tape can be used to plug any undesired leaks due to the relocation of a spot sprinkler.

### DRAWINGS

A brief description of the drawing figures:

FIG. 1 shows an exploded view of the sprinkler parts indicating how they are assembled.

FIG. 2a is a top view of the preferred embodiment of the spot sprinkler.

FIG. 2b is a front view of the sprinkler as attached to a hose.

FIG. 2c is a side view also showing attachment to a hose.

FIG. 3 is a top view of an alternate configuration which sprinkles a circular pattern around the sprinkler.

FIG. 4 is a sectional view of the above alternate configuration taken along line 1-1 of FIG. 5.

FIG. 5 is a side view of the first alternate configuration showing the pin and rotor retainer above the rotor, which spins on the water jet tube.

FIG. 6a is an end view of the rotor sleeve showing the outlet jet angles which cause rotation of the rotor.

FIG. 6b includes 3 sectional views along the 2-2, 3-3, and 4-4 lines showing varying elevation angles of the jets out of the rotor sleeve.

FIG. 7a shows a second alternate configuration with a non-rotating diverter which has a selection of deflector paths to impose narrow or wide spray patterns on the water jet.

FIG. 7b shows the different deflector channels in bottom and side views of the non-rotating diverter.

FIG. 8 shows the larger sprayer body and jet tube which screw into larger plastic tubing used for commercial sprinklers.

FIG. 8a depicts an alternate base assembly which has spring loaded clamp arms suitable for use with hose or tubing of varying diameters. Contoured finger pads enable firmer grip for either installation, or removal of a sprinkler base assembly. This design can be sized for use with any of the embodiments herein.

FIG. 9 is a sketch showing typical spray patterns of the preferred and alternate sprinkler configurations.

Reference numbers in drawings

| Assemblies | Parts | Features |
|---|---|---|
| Preferred embodiment | | |
| 40 Base assembly | 10 axle pin | 30 pivot boss |
| 41 Spray diverter assy | 11 spray diverter spinner | 31 pivot clamp arms |
| | 12 diverter carriage | 32 hose clamp arms |
| | 13 base body | 33 lift tabs |
| | 14 short jet tube | 34 pull off knob |
| Additional embodiments | | |
| 42 rotor assembly | 15 pin | |
| 43 rotor retainer carriage | 16 rotor retainer plate | |
| 44 magnum base assy | 17 rotor core | |
| | 18 rotor sleeve | |
| | 19 long jet tube | |
| | 20 spring washer | |
| | 21 stationary diverter | |
| | 22 magnum jet tube | |
| | 23 magnum base body | |
| | 24 magnum diverter | |
| | carriage | |
| | 25 pipe thread insert | |
| | 26 alternate base and | |
| | hose clamp arms | |
| | 27 spring | |

### DETAILED DESCRIPTION OF THE PREFERRED EMBODIMENT

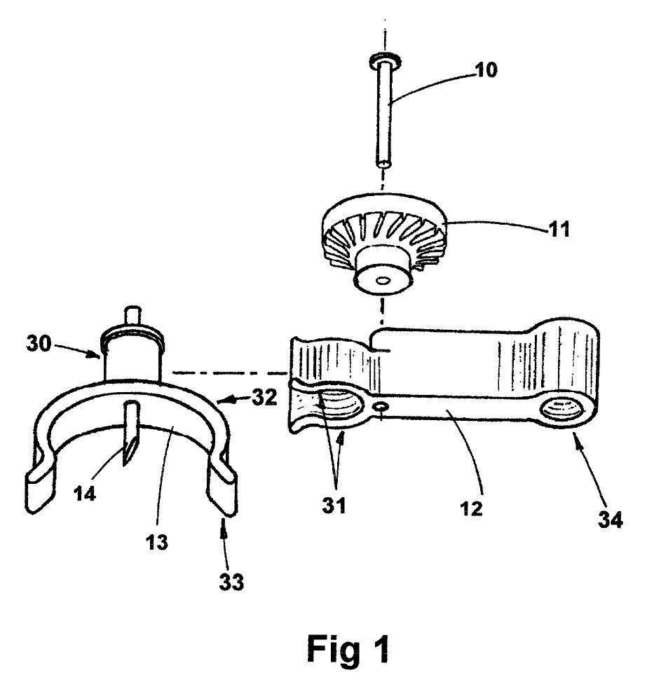

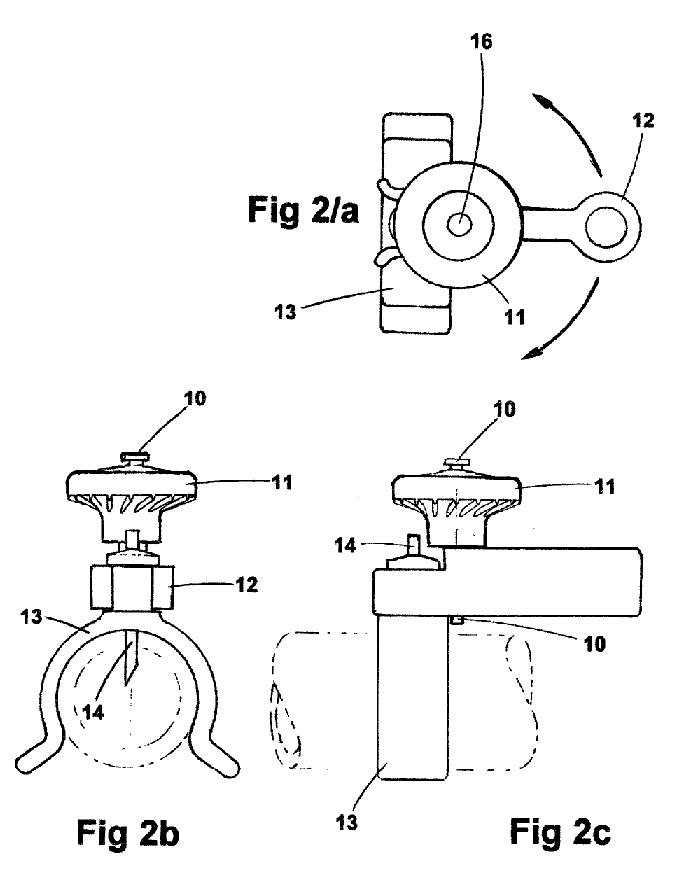

My spot sprinkler has been developed to fill a need for watering specific plants and areas without watering the entire area. The sprinkler shown in FIGS. 1 and 2 consists of a base assembly, and a spray diverter assembly.

The base assembly includes a plastic base body 13 with a water jet tube 14 pressed or molded into the body. The body has hose clamp arms 32 which secure the sprinkler to a soft hose, (not part of the invention). As thus installed, the sharp end of the jet tube penetrates the hose into the water stream.

The diverter assembly includes a plastic diverter carriage 12, and a spray diverter spinner 11, secured to it with a stainless steel axle pin 10. The diverter carriage has flexible arms 31 which are sized to snap onto the pivot boss 30 of the base body 13. Thus positioned, the spray diverter spinner is located above the water jet tube so that the jet impinging on the spinner 11 is diverted outward. Vanes and channels on the underside of the spinner FIG. 2 are impacted by the diverted water jet, and cause the spinner to rotate rapidly. This action causes the water to spray outward over a 20 to 30 degree lateral angle

The spray diverter assembly can be turned about the pivot boss 360 degrees to direct the spray to plantings near the sprinkler. The diverter assembly can be easily removed from the base assembly by pulling backwards on the pull-off knob 34 molded into the diverter carriage 12. This enables clearing the jet tube of any obstruction with a small wire. A common paper clip can be used for most jet tube sizes.

The base assembly 40 can be removed from the hose by lifting on the lift tabs 33 which extend outward on the ends of the hose clamp arms 32. This enables easy relocation of the sprayer to a new location. Holes left in the hose can be plugged temporarily with a common round toothpick. Such holes can be more permanently covered when the outside of the hose is dry, with several turns of plastic electrical tape, available in most hardware stores.

Although not part of this invention, a suitable hose is the ubiquitous “soaker” hose. This hose is erratic in its water disbursement, and quickly silts up in use. It is, however, cheap, readily available, and easily penetrated.

Additional Embodiments

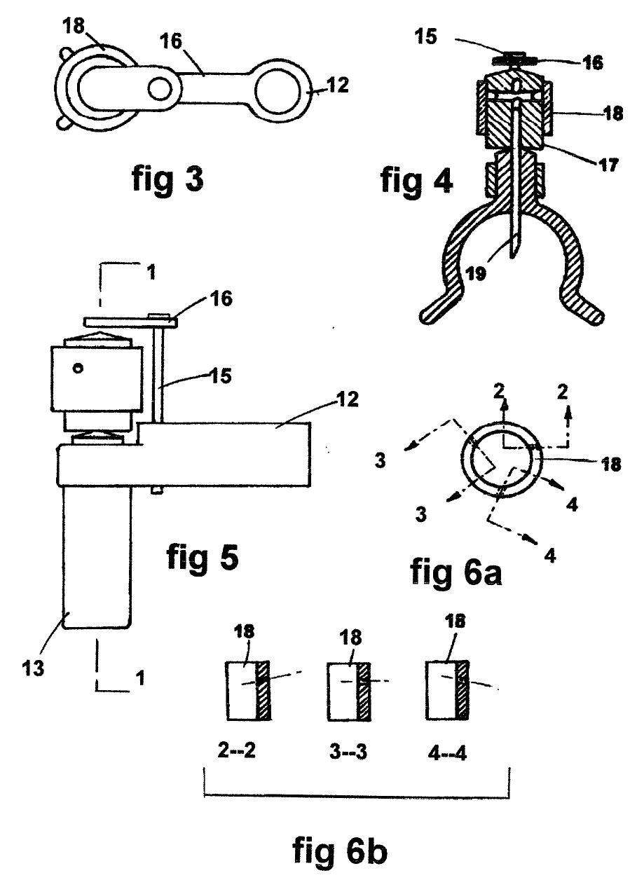

An alternate embodiment of my spot sprinkler is shown in a top view FIG. 3. and side view FIG. 5. An end view sectioned along line 1-1 (of FIG. 5) is shown in FIG. 4. This sprinkler differs from the preferred design in that a rotor is provided which rotates on the long jet tube (19). Jets of water out of the orifices in the outer sleeve of this rotor cause the rotor to spin, and spray a circular area around the sprinkler. A small plate 16 attached to the diverter carriage by pin 15, prevents the rotor from being pushed off the jet tube by water pressure, and serves as a flat bearing for the conical end of the rotor to spin against. This plate is welded, or brazed, to the rotor retainer pin. Water passages within the 2 pieces of the rotor are shown in FIGS. 4, 6a, and 6b. Rotor parts are machined of plastic rods and press fit and/or cemented together.

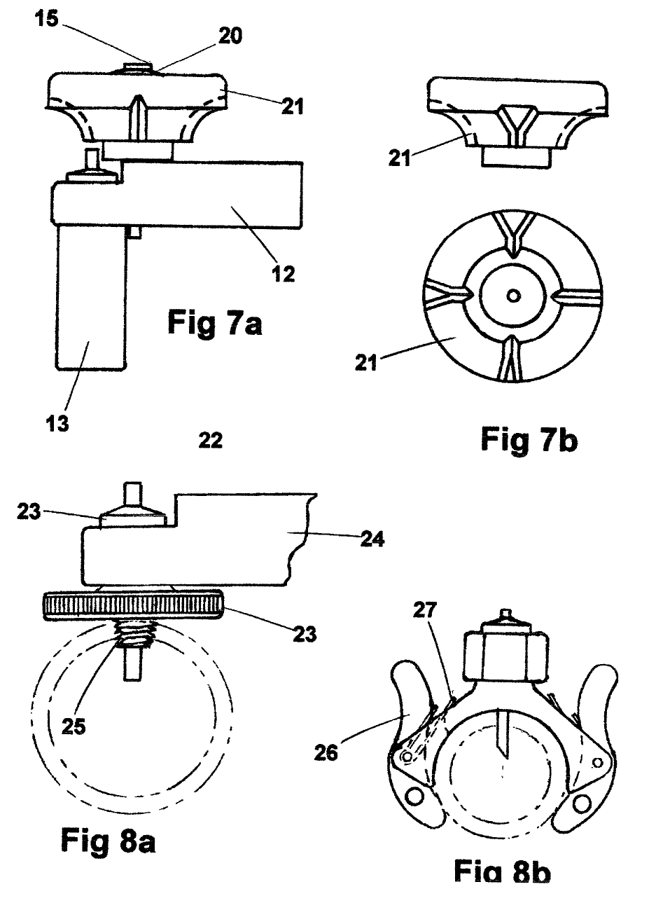

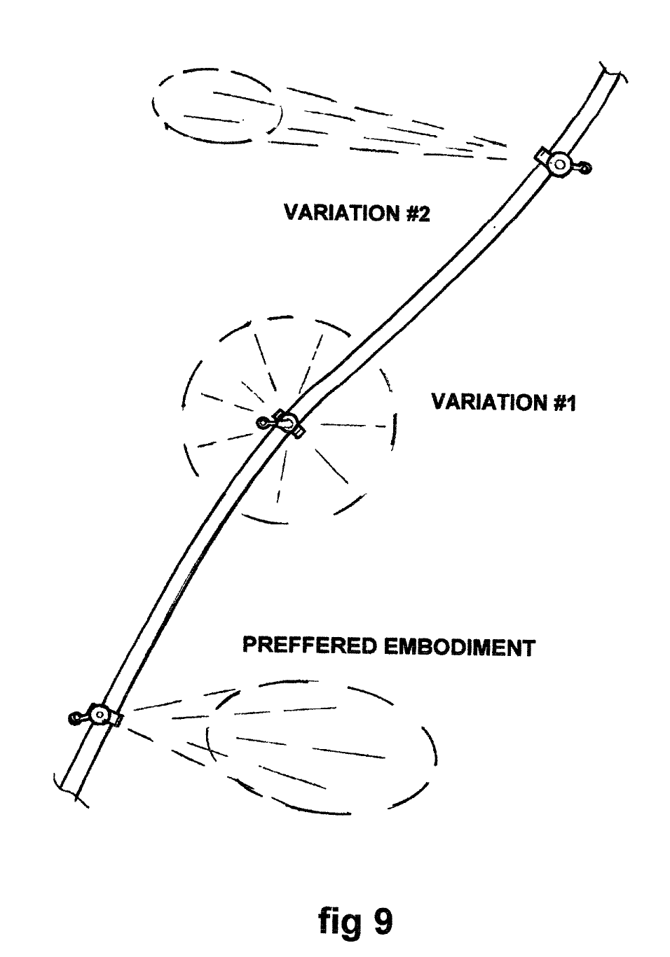

Another embodiment of the spot sprinkler is shown in FIGS. 7a and 7b. This concept differs from the preferred configuration in that a stationary diverter is pinned to the diverter carriage by pin 15. A spring washer atop the diverter holds in firmly in place, but allows manual turning of the diverter so that one of the diversion channels in its under periphery is lined up with the water jet tube. These channels allow selection of a narrow, or wider fan-shaped spray away from the sprinkler. The object of this configuration is to enable more concentrated sprinkling of the area farther from the spot sprinkler.

The last embodiment of my spot sprinkler, FIG. 8a, is of a larger variation suitable for commercial use on farms or orchards. Such sprinklers will be installed on pipe or tubing larger than 1″ diameter, where insertion of a sharpened spray tube through the side wall is impractical. The magnum base assembly has a plastic base body 23, with a large jet tube 22, and an insert with tapered pipe threads 25, extending downward from it. The base assembly can be turned into holes drilled, or melted, into the ABS plastic tubing used for many commercial installations. The magnum diverter carriage 24 and parts assembled to it are similar to those in the preferred and additional embodiments, except appropriately larger. Holes in the supply tubing, due to relocation of a magnum spot sprinkler, can be plugged with easily available pipe plugs.

An alternate base design FIG. 8b, has spring loaded arms to clamp the base assembly to a supply hose or tube. Finger pockets extending from the arms provide a secure grip for installation or removal of the base assembly.

Operation:

Use of this spot sprinkler requires only that a supply hose be connected to a water source, and located among, or along the edge of the plants to be sprinkled. At spots near the selected water targets, sprinkler bodies 13 must be pressed down so that the jet tubes penetrate the hose, and the clamp arms secure the sprinkler bodies to the hose.

Data to be supplied with the sprinklers will show water flow in gal/hr for each sprinkler size (tube size) at normal 30-40 psi pressure. At present only 2-3 sizes are planned. Next, a diverter assembly is snapped onto each sprinkler pivot boss 30 and swiveled to point toward the water targets. Nothing more is required except rodding out of any spray tube which may appear to have reduced flow after a period of time. This is accomplished by pulling the diverter assembly off, and using a small wire, or straightened paper clip, to clean the tube. Occasional flushing of the entire hose out of an end valve may be appropriate for some water systems.

### CONCLUSIONS AND RAMIFICATIONS

It is surely apparent that this spot sprinkler invention will enable the average home-Owner to set up and install a system to meet his needs for watering landscaped areas, or gardens on his property, and to save water by doing so. The emphasis on easy installation, or relocation of sprinklers, and provisions for clean out features are long overdue in the field. Precise rating of small flows, made possible by the use of small straight orifice tubes, and the capability to target small areas, or individual plants, adds to the versatility of this invention. The use of very few, and simple parts suitable for high volume production will result in an inexpensive product.

Although the descriptions contained herein show many specific designs to accomplish the objects stated, these should not be construed as limiting the scope of the invention.

1) A miniature water sprinkler for selective watering of small areas, or individual plants, comprised of:
(a) a base assembly with means of attaching to, and connecting with, a soft hose.
(b) a diverter assembly with means of attaching to the base assembly, and of diverting water jetted from the base assembly.

2) a base assembly as in claim 1a, encompassing a plastic base body, and an embedded metal jet tube.
(a) a plastic base body encompassing:
clamp arms configured to push on and clamp to the soft hose.
a cylindrical boss with an end cap, to mate with, and retain the diverter assembly.
(b) a metal tube extending through the body from above the boss, to between the clamp arms.

3) A spray diverter assembly as in claim 1b, with means of attaching to, and diverting water from the base assembly.
(a) a spray diverter carriage encompassing:
boss clamp arms to mate with, and pivot, on the cylindrical boss of claim 2a.
a pin hole adjacent to the pocket between the boss clamp arms, sized to fit an axle pin.
A round knob opposite the clamp arms on the carriage, to facilitate push on, and pull off, of the diverter assembly from the base assembly.
(b) a spray diverter spinner fastened to the carriage by the axle pin having:
a conical top to bear against the underside of the axle pin head
vanes and channels on the underside of the periphery of the spinner to divert water from the base assembly, causing the spinner to rotate and create a spray away from the sprinkler.

4. The sprinkler of claim 1 with means of creating a more concentrated spray comprising:
(a) a stationary diverter, with selectable channels on the underside which can be manually indexed to align with, and divert the water jet from the base assembly.
(b) an axle pin to secure the stationary diverter to the diverter carriage.
(c) a spring washer between the head of said axle pin, and said stationary diverter to impede rotation thereof.

5. The sprinkler of claim 1 with means of spraying a circular area around the sprinkler comprising the following parts and assemblies:
(a) a base assembly with a longer water jet tube extending upward from the boss thereon.
(b) a rotor assembly closely fit on the long jet tube, with internal passages and orifices to conduct and spray water angularly outward, causing rotation of the rotor, and a circular spray pattern.
(c) a retainer plate connected to the diverter carriage, and positioned above the rotor, thereby serving as a thrust bearing to retain the rotor.

6. The sprinkler of claim 1 with means of connecting to larger tubing, and spraying more water over larger areas comprising:
(a) a magnum base assembly with a magnum jet tube, and a pipe threaded insert connectable to larger, thicker walled tubing.
(b) spray diverter assemblies and parts as in claims 1 thru 5, except of increased size.

7. The sprinklers of claims 1 thru 6 with an alternate base assembly comprising:
(a) a base body with jointed, spring loaded, hose clamp arms.
(b) finger pockets on the clamp arms to grip for installation and removal of the base assembly from the hose.
